(19) United States
(12) Patent Application Publication
(10) Pub. No.: US 2006/0260114 A1
(43) Pub. Date: Nov. 23, 2006

(54) Method And Device For Use In Installing A Cable

(76) Inventors: Colin R. Jewell, Eastleigh (GB); John P. Wilkinson, Romsey (GB)

Correspondence Address: LIEBERMAN & BRANDSDORFER, LLC, 802 STILL CREEK LANE, GAITHERSBURG, MD, 20878, US

(21) Appl. No.: 11/383,131

(22) Filed: May 12, 2006

(30) Foreign Application Priority Data
May 18, 2005 (GB) 0510072.2

(51) Int. Cl. B23Q 3/00

(52) U.S. Cl. 29/464

(57) ABSTRACT

A method and device for use in installing a cable past a desk based on positioning the cable ready for use above a desktop by means of a temporary cable-gripping component and a supporting component adapted to hang adjacent a desktop edge. This provides the advantages of making the installation job quicker and simpler, and allowing it to be performed by just one person. Alternatively, the device can be provided integrally with the cable.

### BACKGROUND OF THE INVENTION

1. Technical Field

This invention relates to the field of cable installation. More specifically, the invention relates to a tool used to facilitate installation of cables that extend from below to above an object.

2. Description of the Prior Art

In the field of cable installation, it is known that when attaching a cable between a computer located below a desk and a peripheral, such as a monitor located above the desk, a common situation may require more than one individual. For example, the installation may require one individual to be under the desk routing the cable, and a second individual to be located above the desk to get the cable above the desk to be plugged into the peripheral. The approach with a single individual is for the individual to push the cable past the rear lip of the desk and to attempt to get the cable to catch on the surface of the desk so that it can be released in order for the individual to return to the top side of the desk to plug the cable into the peripheral. In many circumstances, the cable does not catch on the surface of the desk, and the individual normally spends far longer than needed on this task. Eventually a second individual may come and help hold on to the cable while the first individual is under the desk, but this assumes that a second individual will be present and willing to help. Particular problems are presented by heavy cables such as monitor cables or security locks (which fall more readily), and cables with a smooth profile connector, such USB—Universal Serial Bus—(which generally don't have enough friction to catch).

Therefore, there is a need for a cable retention and retrieval device and method that should alleviate a requirement of two individuals for cable installation.

### SUMMARY OF THE INVENTION

In one aspect of the present invention there is provided an apparatus for use in installing an object. The apparatus includes a first portion for removably holding the object, and a second portion to removably advance through an opening formed adjacent to a secondary object. The second portion of the apparatus is advanced through the opening from a first side of the secondary object to a second side of the secondary object. During the advancement, the object is held in the first portion of the apparatus and advanced through the opening in conjunction with the advancement of the second portion of the apparatus. The object is removed from the first portion of the apparatus at the second side of the secondary object.

In another aspect of the invention a method is provided for installing an object. An installation device is provided with a first portion and a second portion. The object is removable held adjacent to the first portion thereof. The second portion is removeably positioned into an opening adjacent to a first side of a secondary object. The second portion is passed through the opening from the first side of the secondary object to the second side of the secondary object. The object is removed from the first portion of the installation device adjacent to the second side of the secondary object. Thereafter, the installation device is removed from the opening.

### BRIEF DESCRIPTION OF THE DRAWING

One device and method for cable retention and retrieval incorporating the present invention will now be described, by way of example only, with reference to the accompanying drawing, in which:

FIG. 1 shows a cross-sectional view of a device used in installation of a cable from below a desk to above the desk.

### DESCRIPTION OF PREFERRED EMBODIMENT(S)

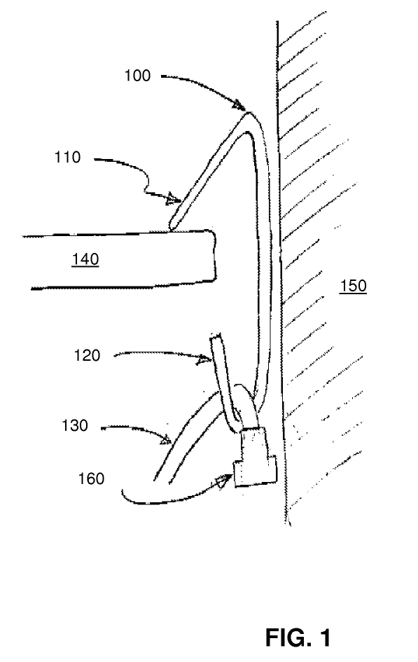

Referring now to FIG. 1, a hand-held, integral moulded device 100 has at its upper end a flap or plate 110 and has at its lower end a hook 120. As will be described, the device 100 is used to facilitate installation of a cable 130 from below a desk 140 to above the desk.

In use of the device 100, an installer below the desk takes the cable 130 (e.g., with one end already connected to a computer—not shown—under the desk) and hangs an unconnected end of the cable over the hook 120 of the device 100. The installer then inserts the device 100 (upper end first) up into a gap between the desk and an adjacent wall 150. As the device is inserted in the gap, the flap or plate 110 resiliently deforms, lying flat (or nearly flat) against the body of the device while within the gap, and allowing the device to progress up the gap, until the lower tip of flap or plate 110 clears the top edge of the desk. In one embodiment, the flap or plate 110 is resilient. When the flap or plate 110 clears the surface of the desk (140), it returns to its non-deformed position as shown, and forms an obstruction which catches on the desk surface near the edge. The device is allowed to remain in this position, with the device hanging on a desk edge by its flap or plate 110. At the same time, the cable remains hanging on the device's hook (120) and the installer may move from below the desk to above the desk.

Once above the desk 140, the installer may lift the device 100 out of the gap formed between the desk (140) and the wall (150) and remove the unconnected end of the cable 130 from the hook 120. The installer then completes the installation by plugging the cable's connector 160 into a desired peripheral device (e.g., a display or monitor—not shown). The device 100 can be stored and re-used for a subsequent installation as desired. In one embodiment, the device is comprised of a plastic material, with the flap or plate (110) having resilient properties.

It will of course be understood that use of the device 100 makes the installation job quicker and simpler, and allows it to be performed by just one person.

It will be understood that the hook 120 at the lower end of the device 100 has a ‘v’ shape, into which the cable to be held is placed, the shaping being chosen so that a variety of thicknesses of cable can be used, and the cable can be wedged in with a large amount of friction restraining it from falling out of the hook (120).

It will be appreciated that although the present invention has been described above in the context of a device 100 separate from the cable 130, alternatively a similar device could be directly incorporated into the cable at its connector 160 or a point adjacent thereto, in which case this alternative device would have only a formation similar to the resilient flap or plate 110 and would not need a formation similar to the hook 120.

It will be appreciated that further possible modifications will be apparent to a person of ordinary skill in the art, without departing from the present invention.

1. An apparatus comprising:
a first portion to removably hold an object; and
a second portion to removably advance through an opening adjacent to a secondary object, from a first side of the secondary object to the second side, while said object is held in said first portion and advanced through said opening with said advancement of said second portion, whereby the object is removed from the first portion at the second side of the secondary object.

2. The apparatus of claim 1, wherein the first portion comprises a hook to hold the object therein.

3. The apparatus of claim 2, wherein the hook comprises a ‘v’ shape adapted to hold one of a variety of thicknesses of said object by wedged frictional restraint.

4. The apparatus of claim 1, wherein the second portion comprises an obstruction to catch on the secondary object.

5. The apparatus of claim 4, wherein the obstruction comprises a member in communication with the second portion to extend through said opening and to catch on the second side of the secondary object.

6. The apparatus of claim 1, wherein the first and second portions are comprised of a plastic material.

7. The apparatus of claim 1, wherein said first portion is integrated with said object as a single unit.

8. The apparatus of claim 1, wherein said object is an elongate item.

9. A method for installing an object, comprising:
removably holding said object adjacent to a first portion of an installation device, and
removably positioning a second portion of the installation device into an opening adjacent to a first side of a secondary object
passing said second portion of the device from the first side of the secondary object to the second side of the secondary object;
removing the object from the first portion of the installation device adjacent to the second side of the secondary object; and
removing the installation device from the opening.

10. The method of claim 9, wherein the first portion comprises a hook to hold the object to the first portion of the installation device.

11. The method of claim 10, wherein the hook comprises a ‘v’ shape adapted to hold one of a variety of thicknesses of said object by wedged frictional restraint.

12. The method of claim 9, wherein the second portion of the installation device comprises an obstruction for catching on the object.

13. The method of claim 102, wherein the obstruction comprises a member extending from the installation device whereby the member can be deformed to allow the installation device to pass through said opening and catching on the second side of the secondary object.

14. The method of any one of claims 9, wherein the first and second portions of the installation device are comprised of a plastic material.

15. The method of claim 9, wherein said first portion of said installation device is integrated with said object as a single unit.

16. The method of claim 9, wherein said object is an elongate item.

17. A device for use in installing a cable, the device being attached to the cable and comprising:
an extending portion for removably holding the device to an object past which the cable is to be installed,
whereby the cable can be installed past the object by holding the device to the object from a first side of the object then removing the device and cable from the object from a second side of the object.
